(19) United States
(12) Patent Application Publication
(10) Pub. No.: US 2026/0322170 A1
(43) Pub. Date: Oct. 15, 2026

(54) SYSTEM, DEVICE AND METHOD FOR EFFICIENT WIRELESS AC POWER TRANSFER UNDER RESTRICTED OPERATING FREQUENCY RANGE

(71) Applicant: B. G. NEGEV TECHNOLOGIES AND APPLICATIONS LTD., Beer Sheva (IL)

(72) Inventors: Alon KUPERMAN, Beer Sheva (IL); Andrey VULFOVICH, Beer Sheva (IL); Yegal DARHOVSKY, Beer Sheva (IL); Vladimir YUHIMENKO, Beer Sheva (IL)

(21) Appl. No.: 19/482,761

(22) PCT Filed: May 10, 2024
(86) PCT No.: PCT/IB2024/054555

§ 371 Date: Nov. 9, 2025

Related U.S. Application Data
(60) Provisional application No. 63/465,269, filed on May 10, 2023.

(51) Int. Cl. H02J 50/12; H02J 50/80; H02M 3/335

(52) U.S. Cl. CPC H02J 50/12; H02J 50/80; H02M 3/33573

(57) ABSTRACT

Embodiments pertain to an inductive wireless power transfer (IWPT) system including: a transmitter circuit and a receiver circuit that resonate at a resonant frequency and operate at an operational frequency, wherein the operational frequency range is limited to operate between a minimum and maximum operational frequency, wherein the transmitter circuit and receiver circuit are configured such that the resonant frequency is higher than the maximum operational frequency. In some examples, a range of coupling coefficients supported within the operational frequency range is greater than would be supported if the maximum frequency was equal or substantially equal to the resonant frequency.

### CROSS-REFERENCE TO RELATED APPLICATIONS

This patent application claims priority and/or benefit from U.S. provisional patent application 63/465,269, filed May 10, 2023, titled “Method and Apparatus for Efficient Wireless AC Power Transfer under Restricted Operating Frequency Range”, and which is incorporated herein by reference in its entirety.

### FIELD

Embodiments disclosed herein relate generally to systems and methods for wireless power transfer.

### BACKGROUND

Wireless power transfer (WPT) systems utilizing an electro-magnetic field as a means of power transfer have been shown as advantageous in comparison to use of wired transfer system as a means of power transfer, providing electrical and mechanical isolation, safety of operation in different environments, and ease of use by consumers. These advantages have driven an increasing interest in wireless power transfer technology in low power applications such implantable biomedical devices which would otherwise be unreachable for purpose of charging and also high-power applications such as, for example, electrical vehicle (EV) charging.

The description above is presented as a general overview of related art in this field and should not be construed as an admission that any of the information it contains constitutes prior art against the present patent application.

### BRIEF DESCRIPTION OF THE DRAWINGS

Non-limiting examples of embodiments disclosed herein are described below with reference to figures attached hereto that are listed following this paragraph. The drawings and descriptions are meant to illuminate and clarify embodiments disclosed herein and should not be considered limiting in any way. Like elements in different drawings may be indicated by like numerals. Elements in the drawings are not necessarily drawn to scale.

FIG. 1 shows a circuit diagram of an inductive wireless power transfer (IWPT) system according to some embodiments.

FIG. 2 shows a fundamental harmonic approximation phasor model of the circuit in FIG. 1, according to some embodiments.

FIG. 3 is a graph of angular frequency versus per-unit output DC current of a sub-resonant controlled SS-compensated IWPT system.

FIG. 4 is a graph of angular frequency versus input DC current of sub-resonant controlled SS-compensated IWPT system.

FIG. 5. is a graph of input current comparison for voltage control and sub-resonant frequency control method under varying coupling conditions.

FIG. 6. is a graph of inverter output impedance phase angle versus operational frequency range.

FIG. 7 is a graph of operational frequency plotted versus output DC per-unit current for an IWPT system implemented with a resonant frequency higher than a maximum operational frequency, according to some embodiments.

FIG. 8 is a graph of an operational frequency plotted versus input DC per-unit current for an IWPT system implemented with a resonant frequency higher than a maximum operational frequency, according to some embodiments.

FIG. 9 shows a flowchart of a process for attaining the generalized design space of an IWPT system implemented with a resonant frequency higher than a maximum operational frequency from which a singular solution may be chosen for implementation, according to some embodiments.

FIG. 10 shows inductance pairs complying with defined design constraints and xᵤ<1, according to some embodiments.

FIG. 11 shows a generalized design space for the defined design constraints in Table I and 0.9≤β≤1, according to some embodiments.

FIG. 12 shows a design sub-space for the design constraints in Table I corresponding to β=1, according to some embodiments.

FIGS. 13A-13C show design sub-spaces for the constraints in Table I corresponding to (a) β=0.97; (b) β=0.94; (c) β=0.91, according to some embodiments.

FIG. 14 shows coil to coil efficiency of a generalized design space for constraints in Table I and 0.9≤β≤1, according to some embodiments.

FIG. 15 is a photograph of an experimental prototype built according to the solution parameters of Table II, according to some embodiments.

FIG. 16 shows the experimental test points set for different combinations of Vₒ and k, according to some embodiments.

FIGS. 17A and 17B show graphs of simulated and experimental efficiency for output voltage of (a) 90V (b) 60V, according to some embodiments.

FIGS. 18A and 18B show input and output AC waveforms for points A, B, C and D of FIG. 16, according to some embodiments.

FIGS. 19A and 19B show input and output DC waveforms for points A, B, C and D of FIG. 16, according to some embodiments.

FIG. 20A shows input and output waveforms for point E F of FIG. 16, according to some embodiments.

FIG. 20B shows input and output waveforms for point F of FIG. 16, according to some embodiments.

### DETAILED DESCRIPTION

An inductive WPT link (IWPTL) may include two loosely coupled coils operating as an air-core loosely coupled transformer (LCT) transferring power from a primary to a secondary coil via an alternating magnetic field. The absence of a magnetic core limits the power transfer capability of a standalone LCT. Operating an IWPT close to resonance with the addition of a compensation network is a widely utilized solution and there are many topologies of varying complexity.

Wireless power transfer systems are typically required to operate under varying geometrical positioning (e.g., vertical distance, tilt, misalignment) between the transmitter and receiver coils while supporting a load with non-constant characteristics. This creates the need for robust systems that can operate over a range of coupling coefficients under time-varying load. Widespread control methods utilized to support such an operation typically suffer from volt-ampere (VA) over-rating of the inductive wireless power transfer link (IWPTL) transmitter.

Sub-resonant frequency control may be an effective solution to this problem, however, allowed operating frequency range may be restricted in practical applications (e.g., to 79 kHz-90 kHz by SAE J2954 electric vehicle (EV) charging standard), limiting the misalignment tolerance of the sub-resonant control method. In a typical sub resonant frequency control system, the maximum operating frequency is substantially equal to the resonant frequency. Such a design is termed a “classical” design herein. It is noted that embodiments disclosed herein may also be applicable with respect to additional or alternative (allowed) operational frequency ranges, as for example regulated or imposed by various industry standards.

In order to overcome the limited misalignment tolerance of the classical design under restricted operating frequencies, described herein are IWPT systems and methods for designing sub-resonant controlled series-series (SS) compensated IWPT systems with minimized transmitter VA rating, allowing maximized misalignment tolerance under restricted operating frequency and output voltage ranges. In the disclosed IWPT systems, according to some embodiments, the maximum operating frequency is greater than the resonant frequency. Although embodiments and examples may herein be disclosed in conjunction with “SS-compensated” systems, this should by no means be construed as limiting. Accordingly, alternative compensation topologies may be employed such as, for example, SP, PP, PS, and LCCL-S topologies.

The proposed systems and methods are validated by simulations and experiments described herein and demonstrate close correlation with analytical predictions. As shown herein, the disclosed IWPT systems may attain, for example, at least about 10%, at least 20%, at least 30%, at least 40%, at least 42%, at least 50%, at least 60%, at least 70% increase in a range of supported coupling coefficients when compared to typical sub-resonant control systems under identical operating conditions, while achieving nearly similar DC-to-DC efficiency.

Near field wireless power transfer systems may be divided into two main categories, capacitive which is mostly utilized for low power applications, and inductive, which may be employed in both low and high-power applications. In inductive wireless power transfer, two inductors may form an LCT, transferring power from a primary to a secondary side via a magnetic field. Standalone power transfer capabilities of an LCT may be limited, requiring compensation networks of various complexity. High-order topologies have been proposed to improve the power transfer, yet this may come at the expense of more system components, lower reliability and complex controllers.

Consequently, SS-compensation, in which both primary and secondary sides of an LCT may be compensated by a single series-connected capacitor, may be chosen due to its relatively low cost, simplicity and compatibility with voltage source converters at both of the transmitting and receiving ends. Furthermore, the performance of this topology was well studied academically and demonstrated in numerous practical applications. When an SS-compensated IWPT system operates at a resonant operational frequency, the system may operate in a load independent current output (LICO) mode, which is highly advantageous for driving constant voltage type (CV) loads such as, for example, EV batteries (in contrast to possible load independent voltage output mode).

In IWPT systems, output may be greatly affected by the relative geometrical positioning between the primary and secondary LCT coils. Variation in positioning may be common in practical applications and causes a change in magnetic coupling between the two coils which must be overcome in order to keep a constant output. Sub-resonant control, where an operational frequency is lower than the resonant frequency, has proven to be advantageous over other methods since it removes the need for additional DC/DC converters used in input voltage control.

Sub-resonant control may allow attaining of inverter transistor zero voltage switching (ZVS) over the whole operational range (in contrast to phase shift control where achieving ZVS is often challenging) and may keep the required inverter VA rating almost constant, unlike pulse density modulation, where inverter current rises with decreasing pulse density (a similar problem may be observed in input voltage control when input voltage is decreased). VA rating is minimized by keeping the transmitter side current almost constant over the whole operational range, addressing known concerns about the risk of ground assembly over-temperature caused by high losses.

Since sub-resonant control utilizes frequency variation in order to overcome coupling and load variances, an inherent limitation becomes apparent when the system is required to operate within a bounded frequency range imposed by, for example, the SAEJ2954 EV charging protocol. One of the main design constraints of classical IWPT system design methodology is setting the system resonant frequency to the upper bound of allowed operational frequency band value.

Embodiments of the system disclosed herein operates with a resonant frequency higher than the upper bound of the allowable operational frequency range (e.g., by tweaking compensation capacitance), thus enabling an increased coupling coefficients range for an LCT coupler without changing coil values and geometries and while remaining within restricted operational frequency limits. Provided herein are methods for designing, e.g., SS-compensated, IWPT systems operating within restricted sub-resonant frequency region attaining improved coupling tolerance without trading off a minimized VA rating characteristic. As described herein, an LCT design space attained by existing methodology may be a subset of the generalized design space attained by the disclosed approach.

It is noted that although embodiments disclosed herein may pertain to SS-compensated topologies, this by no means be construed in a limiting manner. Accordingly, alternative compensation topologies may be employed as well in conjunction with the invention disclosed herein.

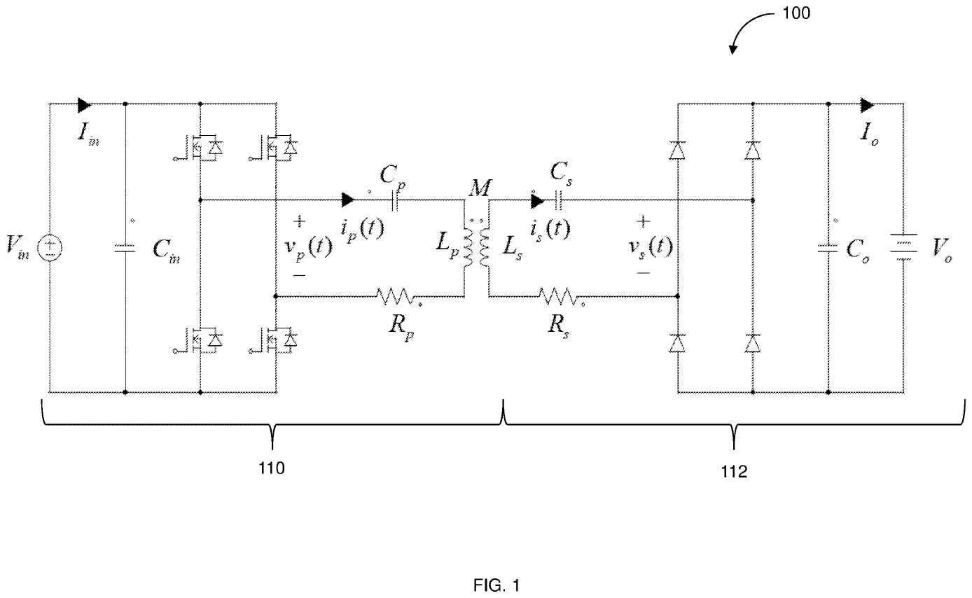

FIG. 1 shows a circuit diagram of an IWPT system according to some embodiments. A system 100 as shown in FIG. 1 includes an active full-bridge DC/AC converter on primary side 110 and passive full-bridge AC/DC converter on secondary side 112. The primary side converter is fed from a DC voltage source Vᵢₙ with corresponding current Iᵢₙ while the secondary-side converter feeds a DC voltage source Vₒ (which models a CV type load such as, for example, EV battery) with corresponding current Iₒ.

In some embodiments, SS-compensation is formed by capacitor Cₚ placed in series with primary side coil Lₚ and capacitor Cₛ placed in series with secondary side coil Lₛ. Primary and secondary AC side voltages and currents are denoted as vₚ(t), vₛ(t), iₚ(t), iₛ(t), respectively, M=k\sqrt{LₚLₛ} is the mutual inductance of the LCT with k signifying the coupling coefficient. Equivalent series resistances of primary and secondary side sub-circuits are marked as Rₚ and Rₛ, respectively.

Assuming continuous conduction mode (CCM) of the secondary side rectifier, primary and secondary AC side voltages are given by:

$${v}_{p} ( t ) ≅ \{ \begin{matrix}{V}_{in} , & 0 \leq ω t < π \\ - {V}_{in} , & π \leq ω t < 2 π\end{matrix} \qquad ( 1 )$$

$${v}_{s} ( t ) ≅ \{ \begin{matrix}{V}_{o} , & 0 \leq ω t + θ < π \\ - {V}_{o} , & π \leq ω t + θ < 2 π\end{matrix} ,$$

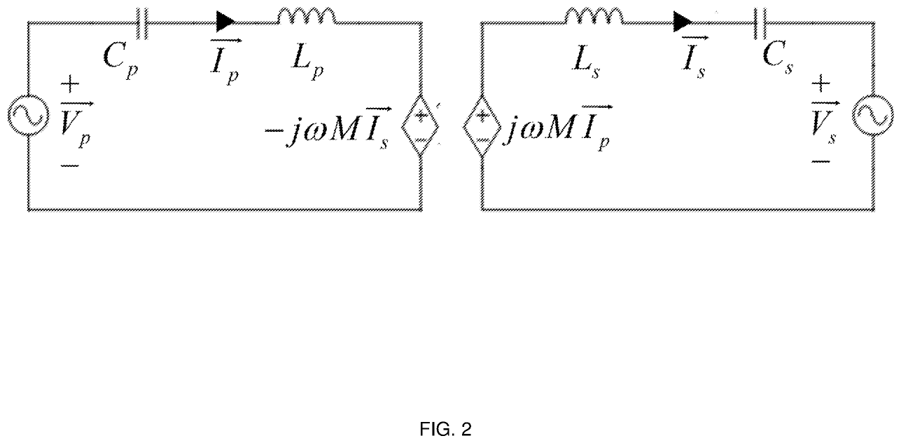

with ω denoting the operational angular frequency and ϑ symbolizing a phase difference between the voltages. CCM operation of the rectifier also implies that a secondary side AC current is in phase with a corresponding voltage. A simplified Fundamental harmonic analysis (FHA) (equivalent series resistances are omitted for initial analysis without loss of generality) is a phasor model of the circuit in FIG. 1 as depicted in FIG. 2 with subsequent voltage fundamental harmonics denoted as:

$${\vec{V}}_{p} = {\underbrace{\frac{4}{π} {V}_{in}}}_{{V}_{p}} ∠0 = {V}_{p} ∠0 , {\vec{V}}_{s} = {\underbrace{\frac{4}{π} {V}_{o}}}_{{V}_{s}} ∠θ = {V}_{s} ∠θ . \qquad ( 2 )$$

In resonance, corresponding current fundamental harmonics are given as:

$${\vec{I}}_{p} = {\underbrace{\frac{π}{2} {I}_{in}}}_{{I}_{p}} ∠0 = {I}_{p} ∠0 , {\vec{I}}_{s} = {\underbrace{\frac{π}{2} {I}_{o}}}_{{I}_{s}} ∠θ = {I}_{s} ∠θ . \qquad ( 3 )$$

Analysis of the circuit in FIG. 2 yields the following equations:

$${\vec{V}}_{p} = {jX}_{p} {\vec{I}}_{p} - {jX}_{M} {\vec{I}}_{s} , \qquad ( 4 )$$

$${jX}_{M} {\vec{I}}_{p} = {jX}_{s} {\vec{I}}_{s} + {\vec{V}}_{s} ,$$

$$with$$

$${X}_{p , s} = ω {L}_{p , s} - \frac{1}{ω {C}_{p , s}} , {X}_{M} = ω M . \qquad ( 5 )$$

Solving (5) with (2) and (3) for output DC current Iₒ at resonant frequency:

$${ω}_{0} = \frac{1}{\sqrt{{L}_{p} {C}_{p}}} = \frac{1}{\sqrt{{L}_{s} {C}_{s}}} \qquad ( 6 )$$

results in:

$${I}_{o} ( {ω}_{0} ) = \frac{8 {V}_{in}}{{π}^{2} {ω}_{0} k \sqrt{{L}_{p} {L}_{s}}} . \qquad ( 7 )$$

Similarly, a corresponding input DC current is obtained as:

$${I}_{in} ( {ω}_{0} ) = \frac{{V}_{o} {I}_{o} ( {ω}_{0} )}{{V}_{in}} = \frac{8 {V}_{o}}{{π}^{2} {ω}_{0} k \sqrt{{L}_{p} {L}_{s}}} . \qquad ( 8 )$$

Examining the power balance of a lossless system with rated CC output Iₒ=I_{o,r} under varying coupling coefficient, there is:

$${P}_{in} = {V}_{in} {I}_{in} = {V}_{o} {I}_{o , r} \to {I}_{in} = \frac{{I}_{o , r} {V}_{o}}{{V}_{in}} . \qquad ( 9 )$$

When input voltage control is applied (i.e. the value of Vᵢₙ is varied) in order to keep the rated CC output under varying coupling conditions, boundary cases corresponding to minimum and maximum coupling coefficient may be formulated as (cf. equations (7)-(9)):

$$k = {k}_{min} \to {V}_{in} = {V}_{in , min} = \frac{{π}^{2} {ω}_{0} \sqrt{{L}_{p} {L}_{s}} {I}_{o , r}}{8} {k}_{min} , {I}_{in} = {I}_{in , max} = \frac{{I}_{o , r} {V}_{o}}{{V}_{in , min}} = \frac{8 {V}_{o}}{{π}^{2} {ω}_{0} \sqrt{{L}_{p} {L}_{s}} {k}_{min}}$$

$$k = {k}_{max} \to {V}_{in} = {V}_{in , max} = \frac{{π}^{2} {ω}_{0} \sqrt{{L}_{p} {L}_{s}} {I}_{o , r}}{8} {k}_{max} , {I}_{in} = {I}_{in , min} = \frac{{I}_{o , r} {V}_{o}}{{V}_{in , max}} = \frac{8 {V}_{o}}{{π}^{2} {ω}_{0} \sqrt{{L}_{p} {L}_{s}} {k}_{max}} .$$

Inverter VA rating must then accommodate maximum current and voltage values,

S_{AC-DC}=V_{in,max}I_{in,max}, (11)

which may be rearranged by considering (7)-(9) as

$${S}_{AC - DC} = \frac{{V}_{i n , max}}{{V}_{i n , min}} {V}_{o} {I}_{o , r} = \frac{{k}_{max}}{{k}_{min}} {V}_{o} {I}_{o , r} . \qquad ( 12 )$$

It is evident that inverter VA rating significantly exceeds rated load power when operation under a wide range of coupling coefficients is required (i.e. if, e.g., kₘₐₓ=2kₘᵢₙ then inverter VA rating is twice the rated load power).

In order to solve the problem of inverter VA-overrating, sub-resonant control may be used, where the system is forced to operate at and below resonance rather than only at resonance. When operational frequency ω deviates from resonance ω₀, output DC current may be obtained by solving (4) with (2), (3) and (5) as:

$${I}_{o} = \frac{8 {V}_{o}}{{π}^{2} {L}_{s}} \frac{\sqrt{{ω}^{2} ( \frac{{f}^{2}}{{x}_{u}^{2}} - 1 ) + 2 {ω}_{0}^{2} - \frac{{ω}_{0}^{4}}{{ω}^{2}}}}{{ω}^{2} ( {k}^{2} - 1 ) + 2 {ω}_{0}^{2} - \frac{{ω}_{0}^{4}}{{ω}^{2}}} \qquad ( 13 )$$

$${x}_{u} = \sqrt{\frac{{L}_{p}}{{L}_{s}}} \frac{{V}_{o}}{{V}_{in}} . \qquad ( 14 )$$

In order to derive input DC current, inverter output impedance is first signified as:

$${\vec{Z}}_{inv} = \frac{{\vec{V}}_{p}}{{\vec{I}}_{p}} = {jX}_{p} + \frac{{X}_{M}^{2}}{{R}_{a c} + {jX}_{s}} \qquad ( 15 )$$

$${R}_{a c} = \frac{8}{{π}^{2}} \frac{{V}_{o}}{{I}_{o}} . \qquad ( 16 )$$

Then, (15) and (16) are combined with (2)-(4) yielding

$${I}_{in} = \frac{8}{{π}^{2}} \frac{{V}_{in}}{\vert {\vec{Z}}_{inv} \vert} = \frac{8 {V}_{in} ( {R}_{a c}^{2} + {X}_{s}^{2} )}{{π}^{2} \sqrt{{X}_{M}^{4} {R}_{a c}^{2} + {( {X}_{p} ( {R}_{a c}^{2} + {X}_{s}^{2} ) - {X}_{s} )}^{2}}} ) \qquad ( 17 )$$

Feasible sub-resonant operation of the circuit in FIG. 1 is attained for xᵤ<1 (cf. (14)). Under this condition, an operational sub-resonant angular frequency range may be derived:

$${ω}_{p} = \frac{{ω}_{0}}{\sqrt{1 + k}} < ω \leq {ω}_{0} . \qquad ( 18 )$$

For systems designed with xᵤ<1 operating in a sub-resonant region (18), analysis of (13) reveals that for a certain coupling coefficient k₁, decreasing ω yields an increase in Iₒ. Additionally, if ω is kept constant while the coupling coefficient increases to k₂>k₁, Iₒ decreases. It is then clear that for a system operating under a certain coupling coefficient range, CC output may be maintained by regulating the operational frequency.

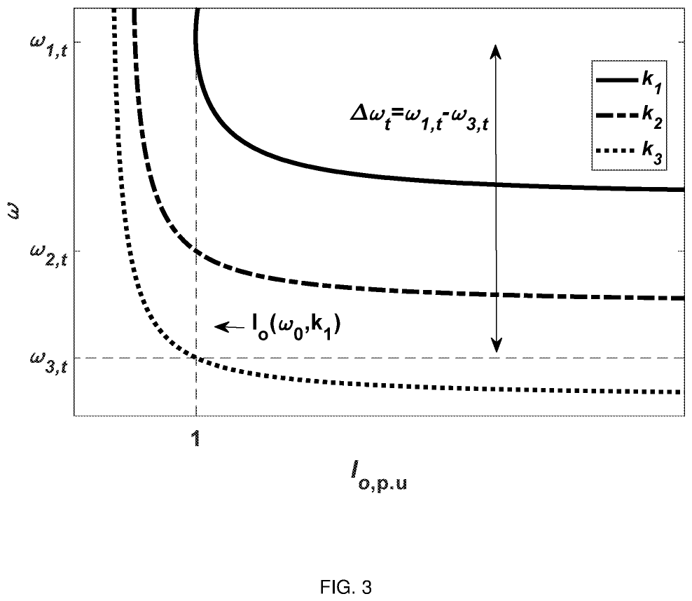

This concept is presented via an example in FIG. 3, where the operational frequency ω is plotted versus output DC per-unit current I_{o,p,u}. For three different coupling coefficient values k₁<k₂<k₃, three corresponding angular frequencies ω_{1,t}>ω_{2,t}>ω_{3,t} are found such that I_{o,p,u}(ω_{1,t}, k₁)=I_{o,p,u}(ω_{2,t}, k₂)=I_{o,p,u}(ω_{3,t}, k₃)=1. In the example of FIG. 3, following the classical design guidelines, the operational frequency is set to the system resonant frequency ω₀ when working at the lower bound of the expected coupling coefficient range.

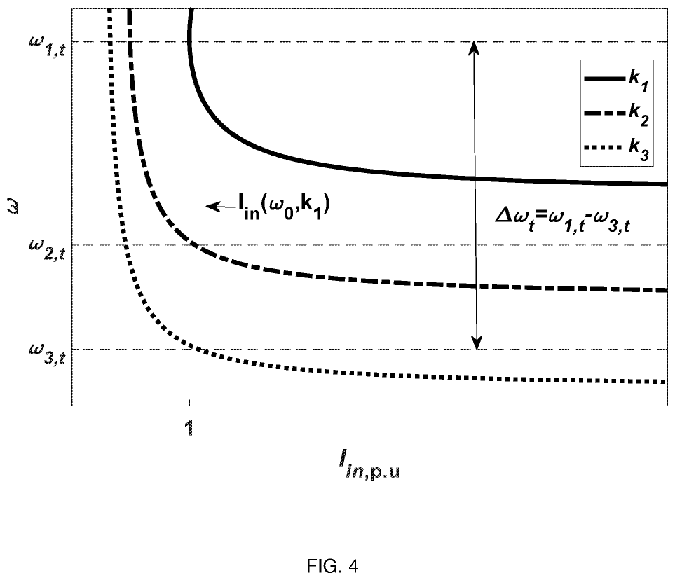

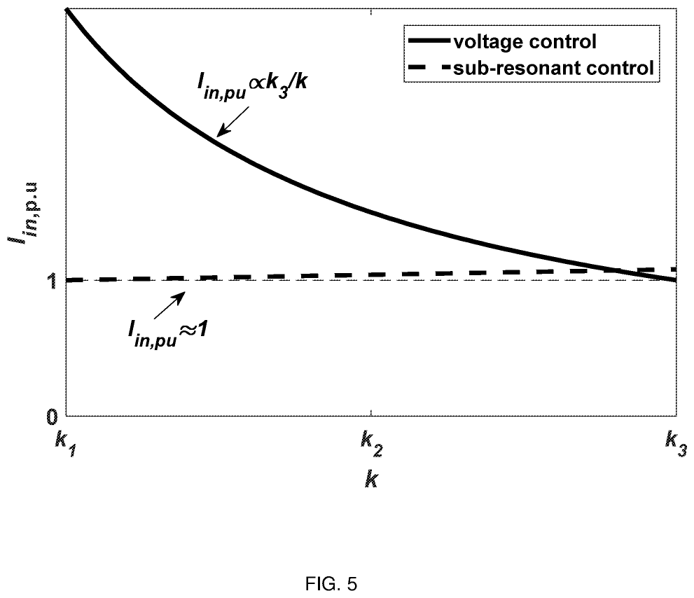

Similarly, as shown in FIG. 4, the operational frequency ω may be plotted versus input DC per-unit current I_{in,p,u}. As shown, the input DC current remains nearly constant during under all coupling conditions. A transmitter VA-rating may be kept nearly constant over the whole operational range—a significant improvement compared to input voltage control cf. (12). To further illustrate the point, FIG. 5 shows input DC current of a sub-resonant controlled system under different coupling conditions compared to input DC current of an input voltage-controlled system.

It may also be shown that operation within a frequency range given by (18) allows attaining ZVS of inverter transistors by deriving the angle of inverter output impedance (15):

$$∠ {Z}_{inv} ( ω ) = ∠ \frac{{\vec{V}}_{p}}{{\vec{I}}_{p}} = arctan ( \frac{( 1 - \frac{1}{{x}_{u}^{2}} ) + \frac{{ω}_{0}^{2}}{{ω}^{2}} ( \frac{1}{{x}_{u}^{2}} - 1 )}{\sqrt{( \frac{{k}^{2}}{{x}_{u}^{2}} - 1 ) + 2 \frac{{ω}_{0}^{2}}{{ω}^{2}} - \frac{{ω}_{0}^{4}}{{ω}^{4}}}} ) . \qquad ( 19 )$$

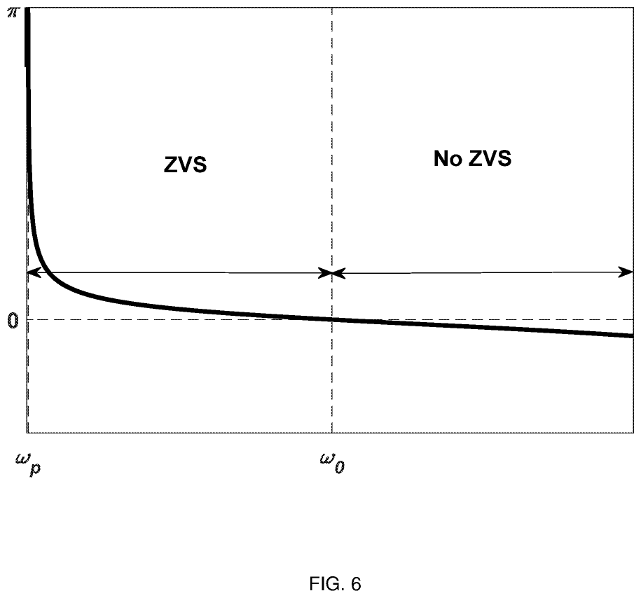

Imposing xᵤ<1 into (19) to allow feasible sub-resonant operation results in a positive inverter output impedance phase angle (necessary to attain ZVS) within the operational angular frequency range (18) (as shown in FIG. 6),

$${∠Z}_{inv} ( ω ) > 0 , {ω}_{p} = \frac{{ω}_{0}}{\sqrt{1 + k}} < ω \leq {ω}_{0} . \qquad ( 20 )$$

Since frequency variation is utilized to regulate output DC current, the obvious limitation of sub-resonant operated systems becomes evident when they are forced to operate within a bounded frequency range typically imposed in practical applications such as, for example, by SAEJ2954 EV charging standard. This constraint, in the context of a sub-frequency control system is explained further below.

Consider an SS-compensated sub-resonant controlled IWPT system, operating within allowed frequency range given by:

ωₘᵢₙ≤ω≤ωₘₐₓ (21)
with constant input voltage Vᵢₙ (e.g. regulated by a mains-interfacing AC/DC converter) and varying output voltage Vₒ (representing terminal voltage of an EV battery during charging), residing within a range given by

V_{o,min}≤Vₒ≤V_{o,max}. (22)

In order to allow xᵤ<1, inductances Lₚ and Lₛ must satisfy:

$${L}_{p} < {{L}_{s} ( \frac{{V}_{in}}{{V}_{o , max}} )}^{2} . \qquad ( 23 )$$

The lower bound of a coupling coefficient range supported to maintain a rated CC output lor may be derived from (7) by setting ω=ωₘₐₓ

$${k}_{mi𝔫} = \frac{8}{{π}^{2}} \frac{{V}_{in}}{{ω}_{max} \sqrt{{L}_{p} {L}_{s}} {I}_{o , r}} , \qquad ( 24 )$$

while a corresponding upper bound may found by solving (9) for k with ω=ωₘᵢₙ, yielding:

$${k}_{max} = \sqrt{\frac{\sqrt{{b}^{2} - 4 a c} - b}{2 a}} \qquad ( 25 )$$

$$a = {( \frac{{π}^{2} {I}_{r} {ω}_{min}^{2} {L}_{s}}{8 {V}_{o , max}} )}^{2} , \qquad ( 26 )$$

$$b = - \frac{2 a}{{ω}_{min}^{2}} {( {ω}_{min} - \frac{{ω}_{max}^{2}}{{ω}_{min}} )}^{2} - {( \frac{{ω}_{min}}{\sqrt{\frac{{L}_{p}}{{L}_{s}}} \frac{{V}_{o , max}}{{V}_{in}}} )}^{2} ,$$

$$c = \frac{a}{{ω}_{min}^{4}} {( {ω}_{min} - \frac{{ω}_{max}^{2}}{{ω}_{min}} )}^{2} ( {( {ω}_{min} - \frac{{ω}_{max}^{2}}{{ω}_{min}} )}^{2} + \frac{{ω}_{min}^{4}}{a} ) .$$

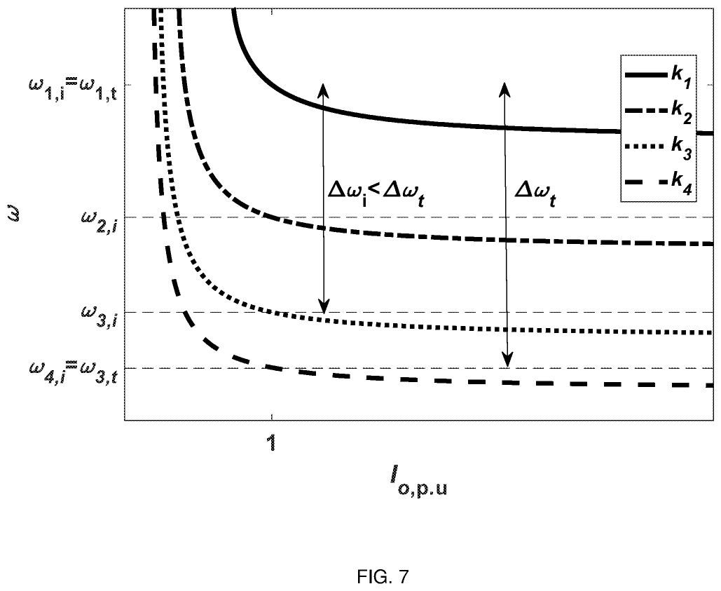

FIG. 7 is a graph of operational frequency plotted versus output DC per-unit current for an IWPT system implemented with a resonant frequency higher than a maximum operational frequency according to some embodiments. As described above, a classical sub-resonant system operates with ω₀=ωₘₐₓ so that the system operates in resonance under k=kₘᵢₙ. In the system disclosed herein the resonant frequency value ω₀ may be set to be higher than the upper bound of an allowed frequency range ωₘₐₓ so that:

$${ω}_{0} = \frac{{ω}_{max}}{β} , 0 < {β}_{min} \leq β \leq 1. \qquad ( 27 )$$

Where 0<βₘᵢₙ≤β<1 represents an IWPT system implemented with a resonant frequency higher than a maximum operational frequency, and where β=1 corresponds to a classical system as described above having a maximum operational frequency substantially equal to a resonant frequency. Accordingly, in some embodiments described herein, 0<βₘᵢₙ≤β<1.

Embodiments of methods and devices are disclosed herein with respect to defining or creating a “design space” for the implementation of an IWPT system. Such design spaces take into consideration multiple parameter values and design IWPT system constraints.

Embodiments of methods and/or devices for defining a design space of an IWPT system may define a condition where 0<β_{min≤β<1}. In some other embodiments, a design space may be designed under conditions where 0<βₘᵢₙ≤β≤1, i.e., encompassing the “classical” system. Also when employed for designing a “classical” system where β=1, the concept of defining or designing a design space as disclosed herein may be considered an embodiment.

In FIG. 7, for an IWPT system implemented with a resonant frequency higher than a maximum operational frequency, an operational frequency ω is plotted versus output DC per-unit current I_{o,p,u} for different coupling coefficient values k₁<k₂<k₃<k₄ (with k_{1,2,3} identical to those in FIGS. 3 and 4). It is evident from comparing FIG. 7 to FIG. 3 that a smaller frequency range Δωᵢ<Δωₜ is sufficient in order to maintain a rated CC output for k₁<k<k₃ when with β<1 (27) is adopted since I_{o,p,u}=1 is achieved for k=k₃ at angular frequency ω_{3,i}<ω_{3,t}.

On the other hand, as also shown in FIG. 7, if the same frequency band is adopted (Δωᵢ=Δωₜ), the range of supported coupling coefficients increases, allowing the IWPT system to support k=k₄>k₃ at ω_{4,i}=ω_{3,t}. This further demonstrates the advantage of an IWPT system designed to have a resonant frequency higher than a maximum operational frequency, e.g., dictated by a standard.

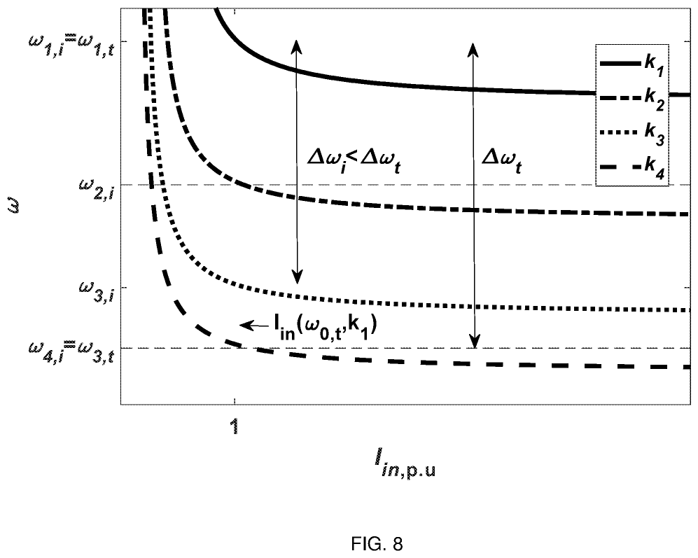

FIG. 8 is a graph of an operational frequency plotted versus input DC per-unit current for an IWPT system implemented with a resonant frequency higher than a maximum operational frequency according to some embodiments. In FIG. 8, an operational frequency ω is plotted versus input DC per-unit current I_{in,p,u}, demonstrating that the primary side DC current remains nearly constant (similarly to a classical system with a resonant frequency substantially equal to a maximum operational frequency such as, for example, shown in FIG. 4).

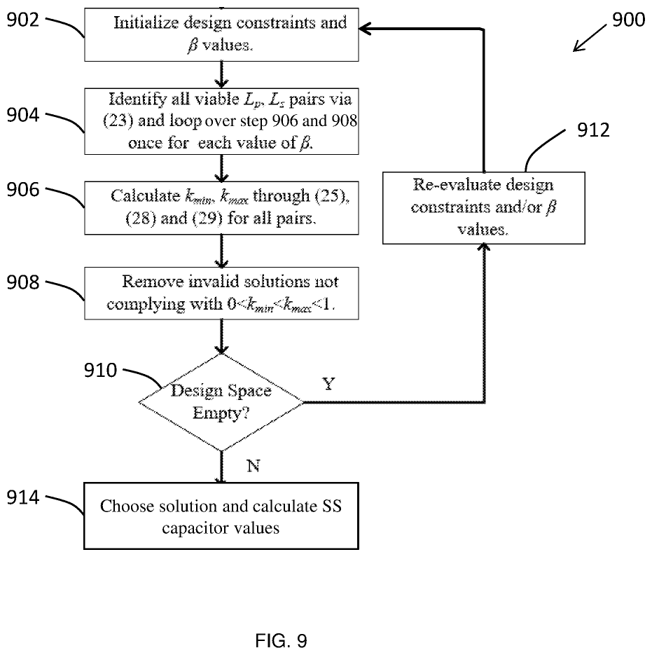

FIG. 9 shows a flowchart of a process 900 for attaining the design space of an IWPT system implemented with a resonant frequency higher than a maximum operational frequency from which a singular solution may be chosen for implementation, according to some embodiments. Process 900 may be performed by a computing device including a processor and memory as described herein. For example, a transitory and/or non-transitory computer readable medium may contain instructions that when executed by the at least one processor, performs the operations described at (each of) the steps in process 900.

In step 902, system design constraints may be chosen according to the desired IWPTL application. These constraints may include, for example, input DC voltage, minimum and maximum values of output DC voltage, rated output DC current, minimum and maximum values of allowed operational frequency range and minimum and maximum values of primary and secondary IWPTL coils inductances. Further, βₘᵢₙ may be determined according to equation (30) as provided below.

In step 904, all viable (Lₚ, Lₛ) pairs may be identified complying with equation (23).

In step 906, for each viable (Lₚ, Lₛ) pair determined in step 904, lower and upper bounds of supported coupling coefficient ranges may be determined according to equations (28) and (29) (below) for each value or values of β meeting the condition 0<βₘᵢₙ≤β<1, or for each value or values of 0<βₘᵢₙ≤β≤1. In step 908, all solutions not complying with 0<kₘᵢₙ<kₘₐₓ<1 may be discarded. Steps 906 and 908 may be repeated for different values of β until the whole range of values of β is covered. The coupling coefficient range bounds kₘᵢₙ and kₘₐₓ may for example be found respectively by:

$${k}_{min} = \sqrt{\frac{\sqrt{{b}_{1}^{2} - 4 {a}_{1} {c}_{1}} - {b}_{1}}{2 {a}_{1}}} \qquad ( 28 )$$

$${a}_{1} = {( \frac{{π}^{2} {I}_{o , r} {ω}_{max}^{2} {L}_{s}}{8 {V}_{o , min}} )}^{2} ,$$

$${b}_{1} = - \frac{2 {a}_{1}}{{ω}_{max}^{2}} {( {ω}_{max}^{2} - \frac{{ω}_{max}}{{β}^{2}} )}^{2} - {( \frac{{ω}_{max}}{\sqrt{\frac{{L}_{p}}{{L}_{s}}} \frac{{V}_{o , min}}{{V}_{in}}} )}^{2} ,$$

$${c}_{1} = \frac{{a}_{1}}{{ω}_{max}^{4}} {( {ω}_{max} - \frac{{ω}_{max}}{{β}^{2}} )}^{2} ( {( {ω}_{max} - \frac{{ω}_{max}}{{β}^{2}} )}^{2} + \frac{{ω}_{max}^{4}}{{a}_{1}} ) ,$$

$${k}_{max} = \sqrt{\frac{\sqrt{{b}_{2}^{2} - 4 {a}_{2} {c}_{2}} - {b}_{2}}{2 {a}_{2}}} \qquad ( 29 )$$

$${a}_{2} = {( \frac{{π}^{2} {I}_{o , r} {ω}_{min}^{2} {L}_{s}}{8 {V}_{o , max}} )}^{2} ,$$

$${b}_{2} = - \frac{2 {a}_{2}}{{ω}_{min}^{2}} {( {ω}_{min} - \frac{{ω}_{max}^{2}}{{β}^{2} {ω}_{min}} )}^{2} - {( \frac{{ω}_{min}}{\sqrt{\frac{{L}_{p}}{{L}_{s}}} \frac{{V}_{o , max}}{{V}_{in}}} )}^{2} ,$$

$${c}_{2} = \frac{{a}_{2}}{{ω}_{min}^{4}} {( {ω}_{min} - \frac{{ω}_{max}^{2}}{{β}^{2} {ω}_{min}} )}^{2} ( {( {ω}_{min} - \frac{{ω}_{max}^{2}}{{β}^{2} {ω}_{min}} )}^{2} + \frac{{ω}_{min}^{4}}{{a}_{2}} ) .$$

Noticing that kₘₐₓ is bounded by unity, the value of βₘᵢₙ may be identified by substituting kₘₐₓ=1 into (29) and solving for βₘᵢₙ:

$$\sqrt{\frac{\sqrt{{b}_{3}^{2} - 4 {a}_{3} {c}_{3}} - {b}_{3}}{2 {a}_{3}}} = 1 \qquad ( 30 )$$

$${a}_{3} = {( \frac{{π}^{2} {I}_{o , r} {ω}_{min}^{2} {L}_{s}}{8 {V}_{o , max}} )}^{2} ,$$

$${b}_{3} = - \frac{2 {a}_{3}}{{ω}_{min}^{2}} {( {ω}_{min} - \frac{{ω}_{max}^{2}}{{β}_{min}^{2} {ω}_{min}} )}^{2} - {( \frac{{ω}_{min}}{\sqrt{\frac{{L}_{p}}{{L}_{s}}} \frac{{V}_{o , max}}{{V}_{in}}} )}^{2} ,$$

$${c}_{3} = \frac{{a}_{3}}{{ω}_{min}^{4}} {( {ω}_{min} - \frac{{ω}_{max}^{2}}{{β}_{min}^{2} {ω}_{min}} )}^{2} ( {( {ω}_{min} - \frac{{ω}_{max}^{2}}{{β}_{min}^{2} {ω}_{min}} )}^{2} + \frac{{ω}_{min}^{4}}{{a}_{3}} ) .$$

The resulting {β, Lₚ, Lₛ, kₘᵢₙ, kₘₐₓ} vectors yield the generalized design space. In step 910, if the design space is empty, then, in step 912 the initial design constraints and values for β may be reevaluated and steps 902 to 908 may be repeated.

In step 910, if a design space is not empty (i.e.: a design space has been determined), then, in step 914, a specific solution may be chosen for implementation from the generalized design space according to e.g. optimization performed according to certain cost function, etc. Further, series compensation capacitor values may be calculated according to:

$${C}_{p} = \frac{{β}^{2}}{{ω}_{max}^{2} {L}_{p}} , {C}_{s} = \frac{{β}^{2}}{{ω}_{max}^{2} {L}_{s}} , \qquad ( 31 )$$

### Examples

In order to compare the performance of the classical and disclosed design methodologies, a set of design constraints were adopted and are summarized in Table I.

TABLE I
DESIGN CONSTRAINTS

| Parameter | Value | Units |
|---|---|---|
| Vᵢₙ | 100 | V |
| Iᵣ | 3.2 | A |
| V_{o, min} | 60 | V |
| V_{o, max} | 90 | V |
| ωₘᵢₙ | 2π · 79k | rad · s⁻¹ |
| ωₘₐₓ | 2π · 90k | rad · s⁻¹ |
| L_{p, min}, L_{s, min} | 50 | μH |
| L_{p, max}, L_{s, max} | 200 | μH |

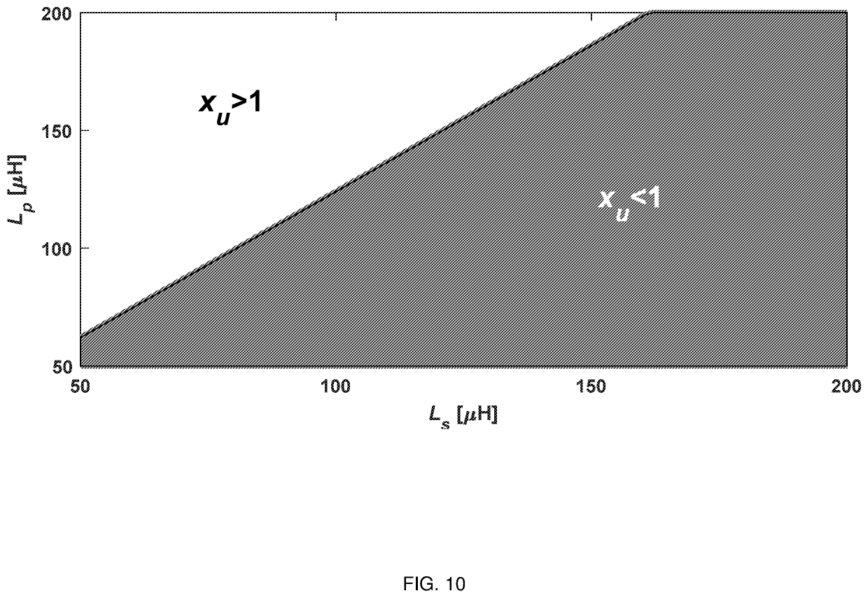

As per process 900, all feasible inductance pairs were identified by combining constraints from Table I with equation (23). FIG. 10 Shows inductance pairs complying with the design constraints and xᵤ<1 highlighted by the greyed area.

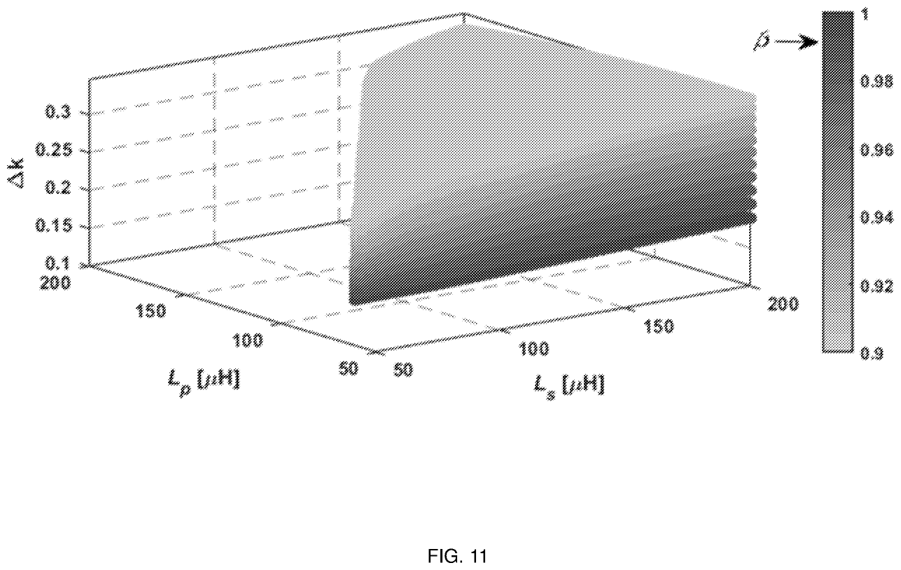

The generalized design space (all valid {β, Lₚ, Lₛ, kₘᵢₙ, kₘₐₓ} vectors) was then obtained according to process 900 with βₘᵢₙ=0.9 chosen for the sake of practical example. The resulting supported coupling coefficient range Δk=kₘₐₓ−kₘᵢₙ was plotted for each {β, Lₚ, Lₛ} trio and FIG. 11 shows the generalized design space for constraints in Table I for 0.9≤β≤1. It is clear that the coupling range increases when β decreases as expected from FIGS. 3 and 6, demonstrating the advantage of the disclosed system over its classical counterpart.

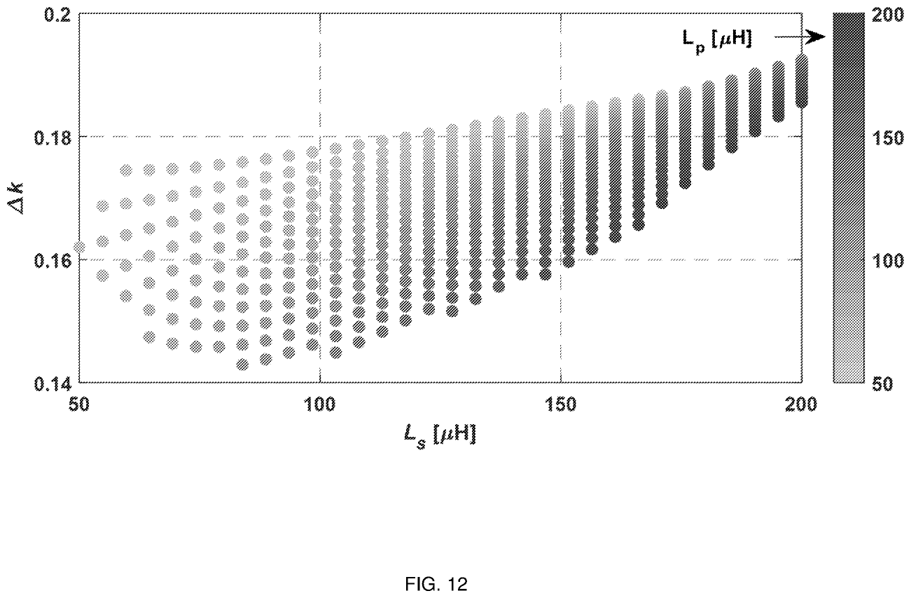

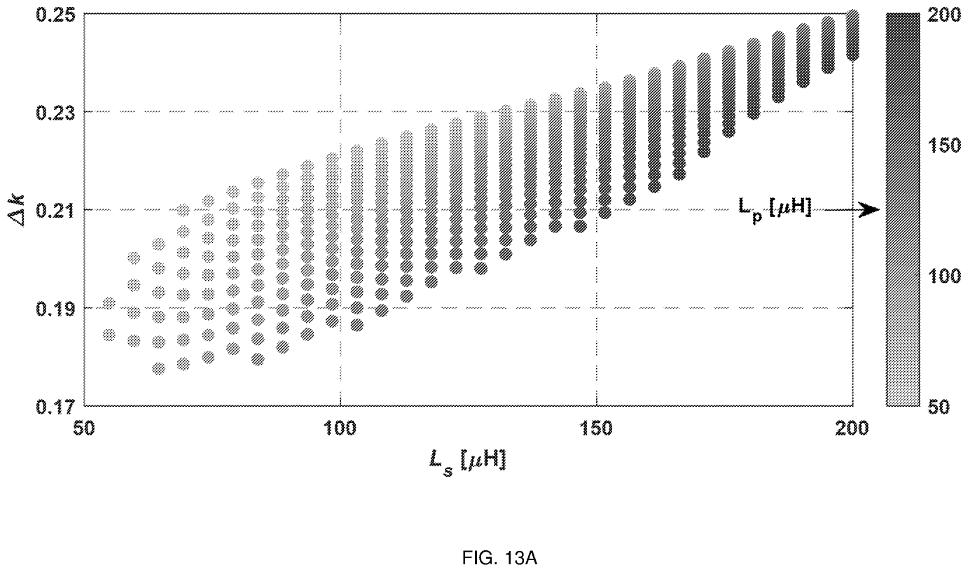

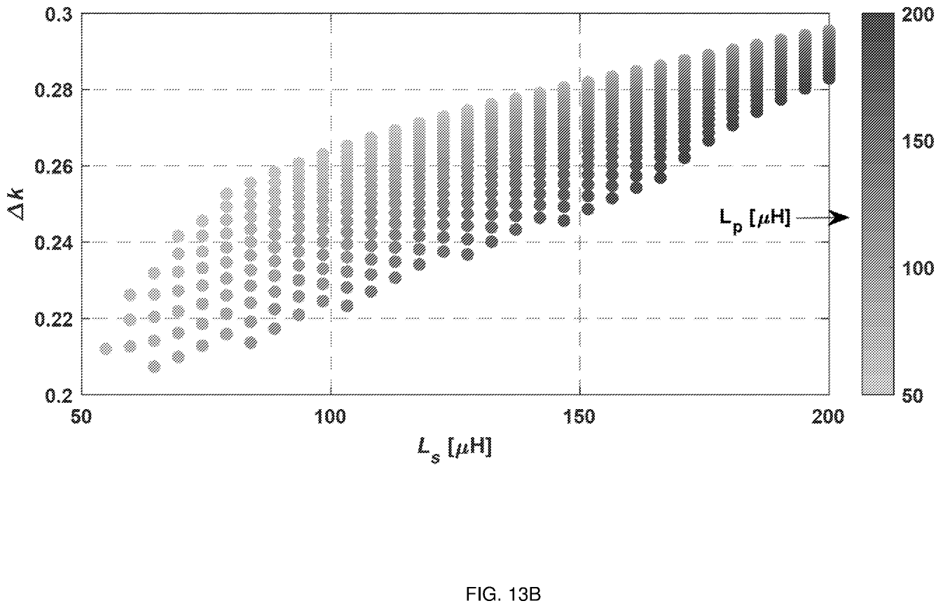

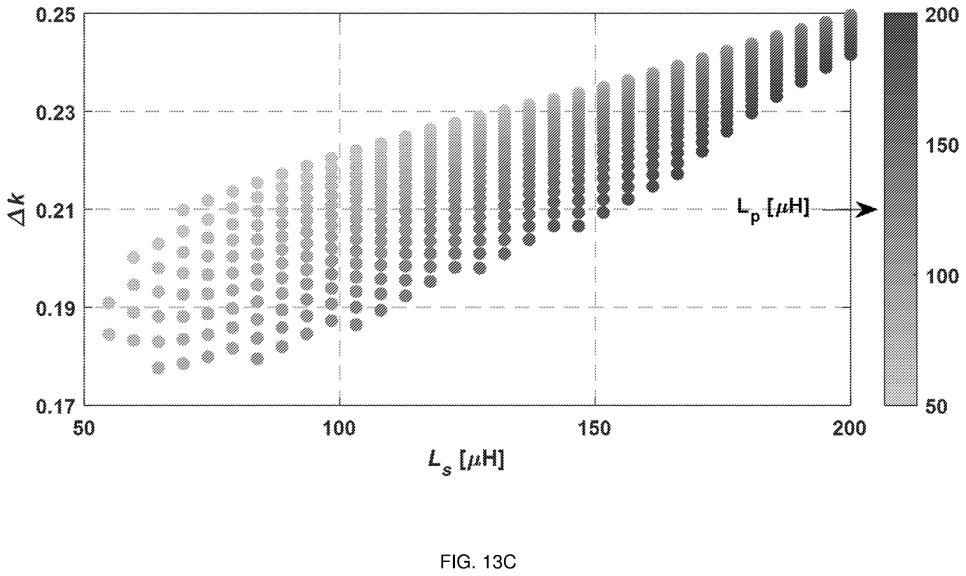

FIG. 12 shows the classical design space (which is a sub-space of the generalized design space obtained for β=1). FIGS. 13A-13C show respectively three design sub-spaces obtained for β=0.97, 0.94 and 0.91 demonstrating higher attainable Δk values. In the classical design space of FIG. 12, the maximum attainable Δk is around 0.19. By contrast, the disclosed system attains a Δk of 0.27, achieving a 42% improvement in the supported coupling coefficient range. It should be appreciated that the disclosed system and method therefore enable higher tolerance for misalignment of coils in an IWPT system.

In order to give further insight into the generalized design space performance, a worst case coil-to-coil efficiency attained at maximum values of coupling coefficient kₘₐₓ and output voltage V_{o,max} may be obtained with:

$$η ( {k}_{max} ) [ \% ] = 100 \frac{{V}_{o , max} ( \frac{2 {I}_{s}}{π} )}{{V}_{o , max} ( \frac{2 {I}_{s}}{π} ) + {{R}_{p} ( \frac{{I}_{p}}{2} )}^{2} + {{R}_{s} ( \frac{{I}_{s}}{2} )}^{2}} \qquad ( 32 )$$

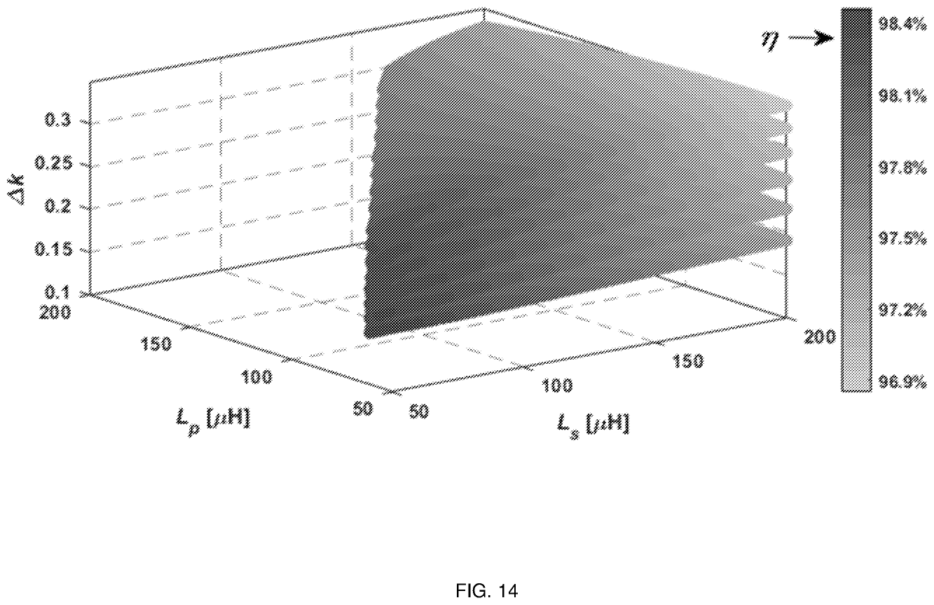

Coreless circular planar coils adopting 300×0.1 mm strands of Litz wire were assumed. Outer and inner diameters were set to 30 cm and 12 cm (adopting practical inner/outer diameters ratio of 0.4) respectively. Coil inductances were adjusted by varying the number of turns, resulting in varying wire length which was used to calculated DC resistance of the coils. Furthermore, skin and proximity effects were considered by scaling the DC resistance by an AC-to-DC resistance factor. The results are summarized in FIG. 14 showing coil to coil efficiency of a generalized design space for constraints in Table I and 0.9≤β≤1, and demonstrating that increased size of supported coupling coefficient range Δk is attained at the cost of slightly lower coil-to-coil efficiency.

In order to experimentally validate the superiority (in terms of misalignment tolerance) of the disclosed design process over the classical one, a solution with parameters summarized in Table II was chosen from the generalized solution space.

TABLE II
SELECTED SOLUTION PARAMETERS

| Parameter | Value | Units |
|---|---|---|
| Lₚ | 180 | μH |
| Lₛ | 200 | μH |
| kₘᵢₙ | 0.3 | — |
| kₘₐₓ | 0.57 | — |
| Cₚ | 15.3 | nF |
| Cₛ | 13.7 | nF |
| Rₚ | 0.3 | Ω |
| Rₛ | 0.35 | Ω |
| β | 0.94 | — |

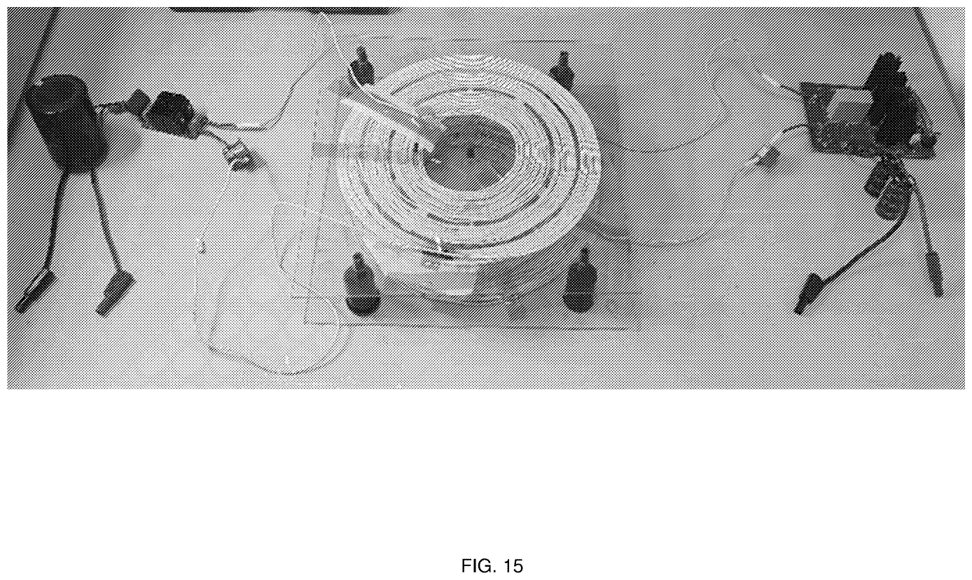

FIG. 15. is a photogrpah of an experimental prototype built according to the solution parameters of Table II. TP65H050WS 650V, 60 mΩ GaN FET transistors driven by SI8230BB drivers were utilized to build the primary side DC-AC converter with a TI TMS320F28335 digital signal processor-based control card. APT40DQ60BG diodes were employed for the secondary AC-DC converter. An IT6012C-800-50 ITECH DC power supply was used as an input voltage source and an M9715B Maynuo DC electronic load was employed as a CV-type load. Input and output DC filter capacitors were sized as Cᵢₙ=1 mF and Cₒᵤₜ=1.12 mF, respectively.

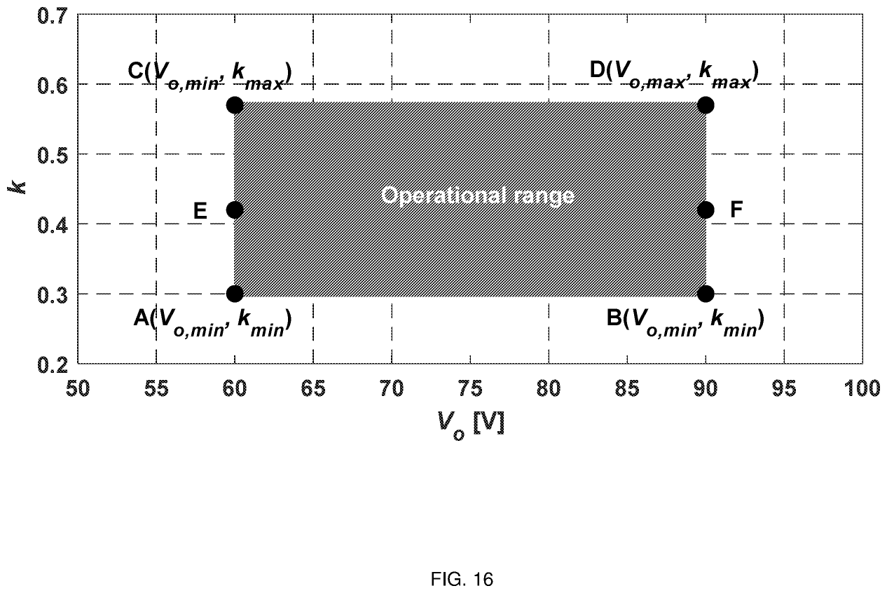

The coupling coefficient between the coils of the LCT was varied by controlling the distance between the coils. FIG. 16 shows the experimental test points set for different combinations of Vₒ and k. To verify the solution compliance with the design constraints in Table I, experiments and PSIM simulation were conducted for the operational range boundary points A, B, C and D shown in FIG. 16. Additional operation points E and F were also examined for more thorough performance assessment.

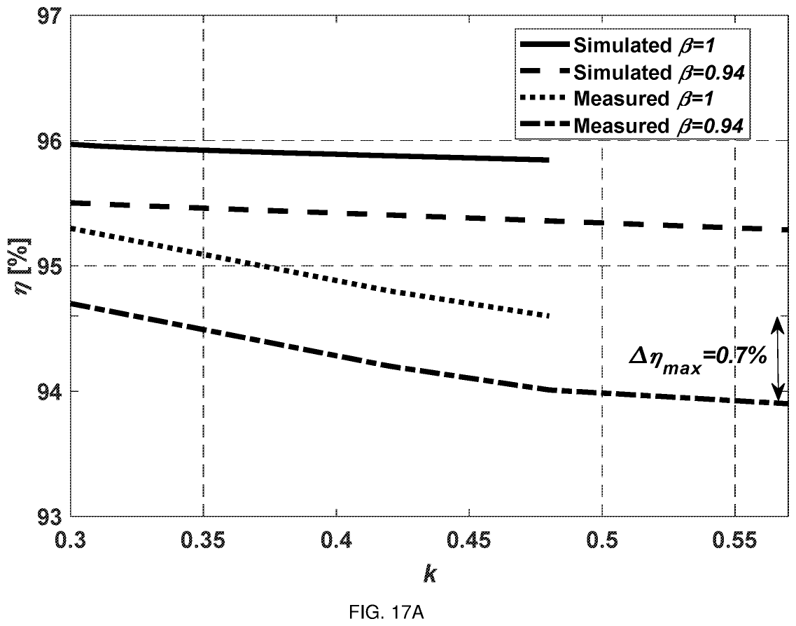

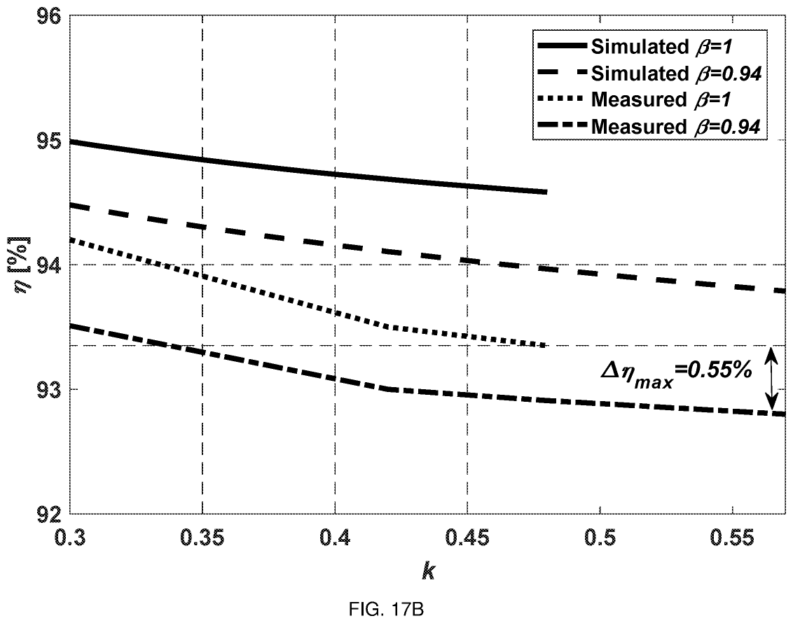

The values of simulated DC-to-DC system efficiency and corresponding measured values are presented in FIG. 17A for output voltage of 60V (points A, C and E) and FIG. 17B for output voltage of 90V (points B, D and F). It is evident that there is indeed a certain tradeoff between system efficiency and supported coupling coefficient range, as predicted by FIG. 14. However, the drop in system efficiency (with maximum value of 0.7%) is rather minor, while the supported coupling coefficient range improvement (42% improvement in Δk) is quite significant.

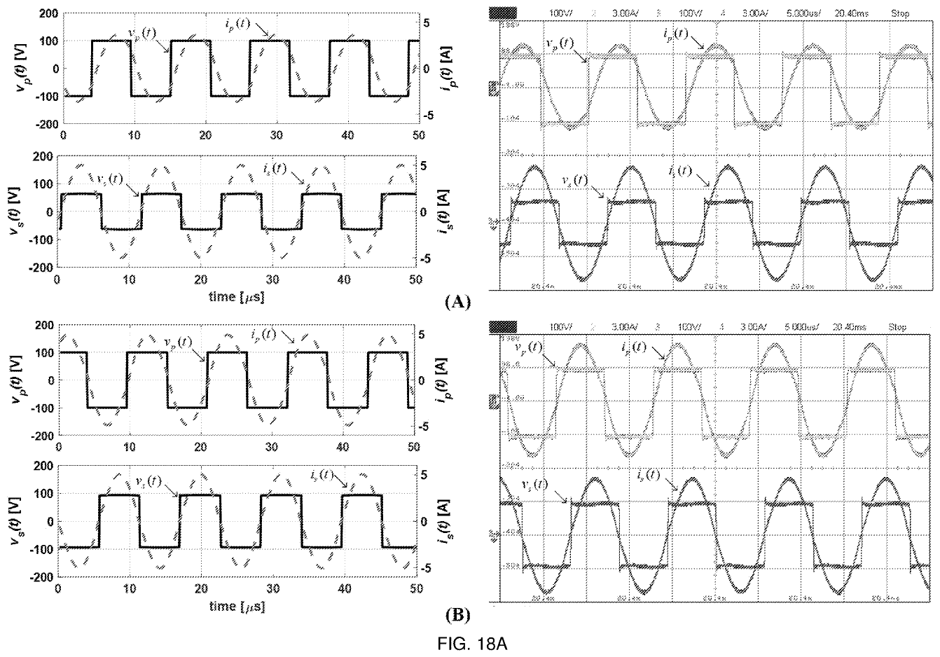

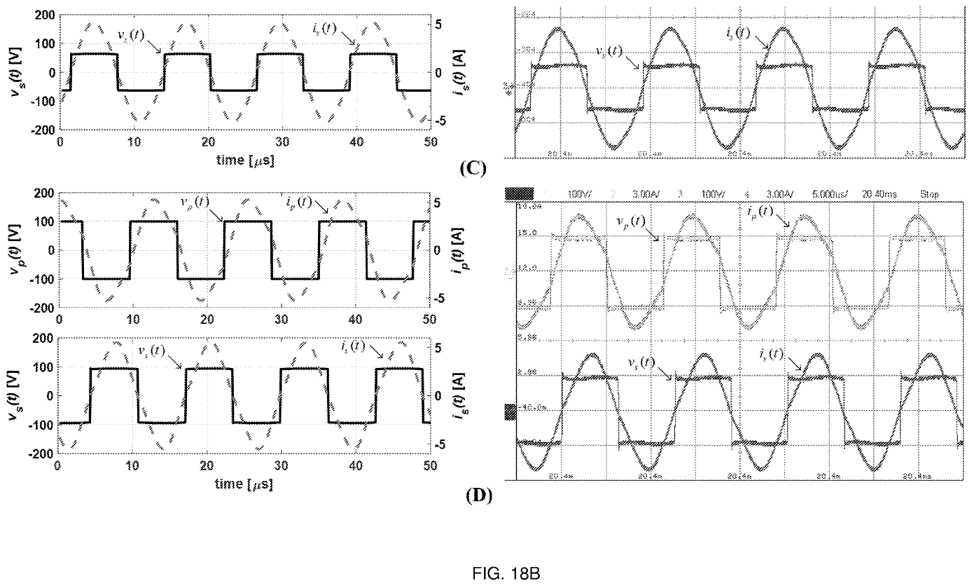

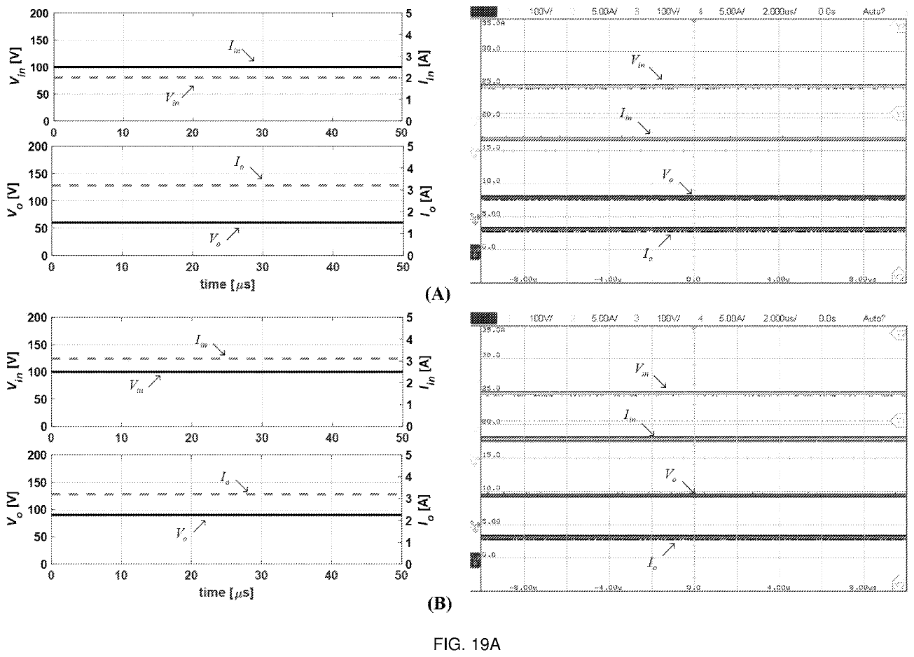

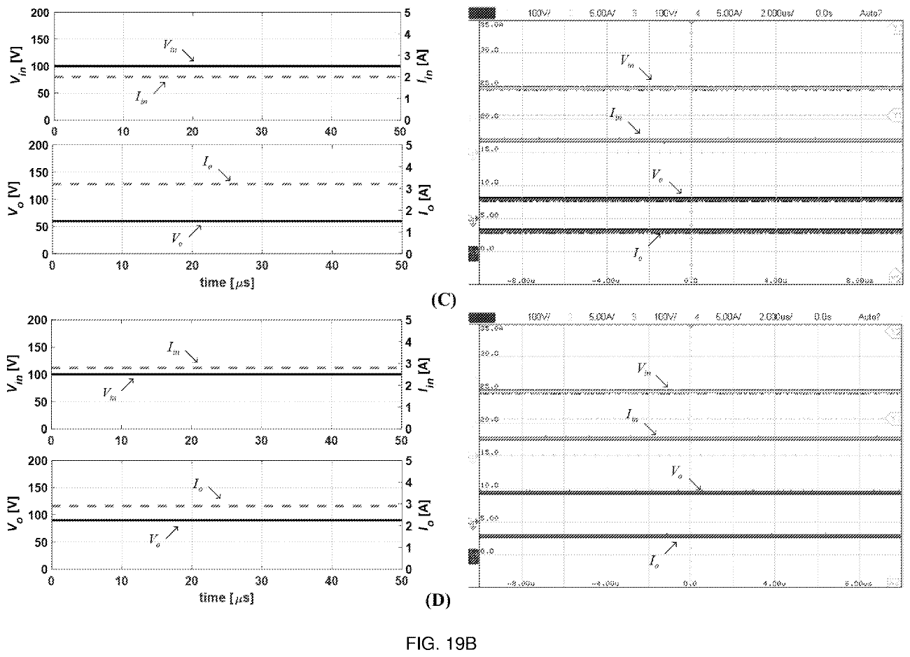

Inverter output and rectifier input AC waveforms for points A, B, C and D are shown in FIGS. 18A-18B with matching input and output DC waveforms presented in FIGS. 19A-19B. Observing FIGS. 18A-18B reveals that primary and secondary current magnitudes remain nearly unchanged for all operational points, demonstrating good agreement with the expectations. Rated output DC current is accurately attained at all operating points too.

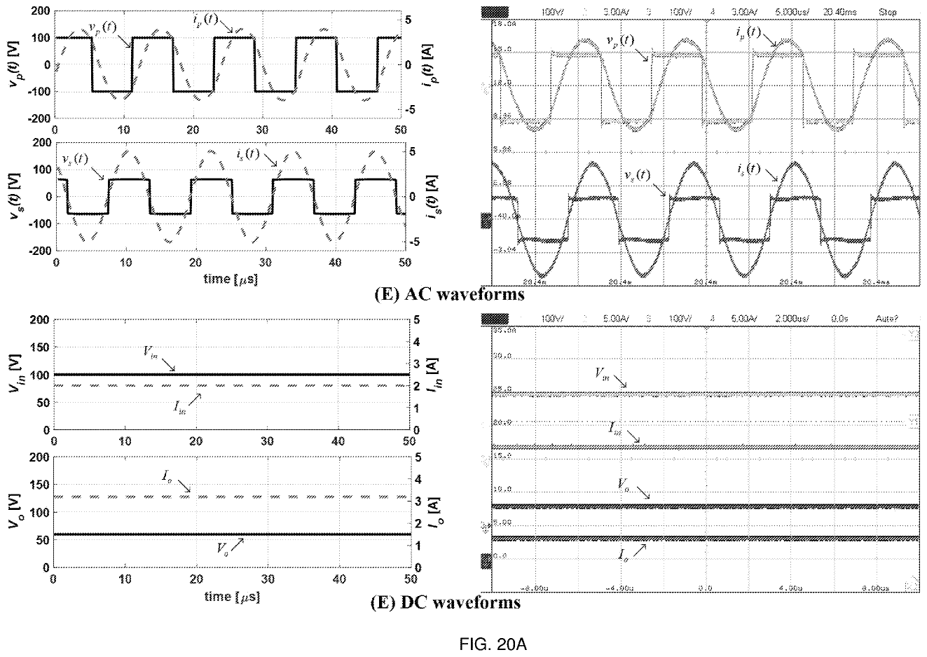

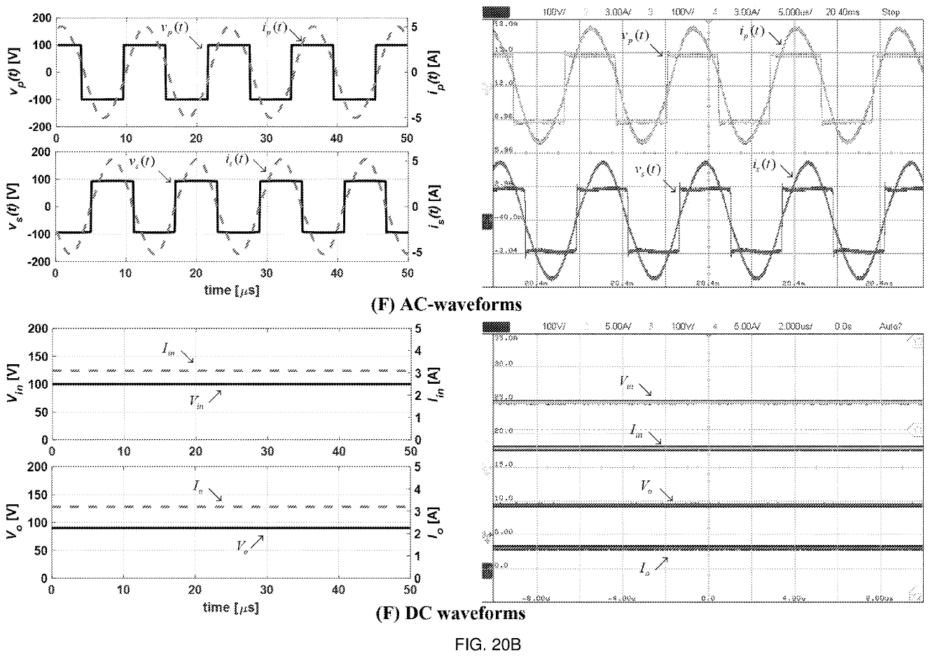

In order to thoroughly validate system performance over a wider part of the operational range, simulations and experiments were performed for an additional (mid-range) coupling coefficient value of k=0.42, at both minimum and maximum output voltage (points E and F in FIG. 16). The resulting AC and DC waveforms are presented in FIGS. 20A-20B where rated output DC current is successfully achieved, and AC waveforms demonstrate good matching with those in FIGS. 18A-18B. Furthermore, ZVS is evident in all test points with inverter output current lagging corresponding voltage (as expected when utilizing sub-resonant control), resulting in lower switching losses and reduced cooling requirements of the primary side inverter.

### Additional Examples

Example 1 pertains to an inductive wireless power transfer (IWPT) system including: a transmitter circuit and a receiver circuit that resonate at a resonant frequency and operate at an operational frequency, wherein the operational frequency range is limited to operate between a minimum and maximum operational frequency, wherein the transmitter circuit and receiver circuit are configured such that the resonant frequency is higher than the maximum operational frequency.

Example 2 includes the subject matter of example 1 and, optionally, wherein a range of coupling coefficients supported within the operational frequency range is greater than would be supported if the maximum operational frequency was substantially equal to the resonant frequency.

Example 3 includes the subject matter of any one or more of the examples 1 to 2 and, optionally, wherein a range of coupling coefficients supported within the operational frequency range is maximized.

Example 4 includes the subject matter of any one or more of the examples 1 to 3 and, optionally, wherein the supported range of coupling coefficients is at least 40% more than would be supported if the maximum operational frequency was equal or substantially equal to the resonant frequency.

Example 5 includes the subject matter of any one or more of the examples 1 to 4 and, optionally, wherein a range of supported coupling coefficients allows for a smaller operational frequency range than would be required if the resonant frequency was equal or was substantially equal the maximum operational frequency.

Example 6 includes the subject matter of any one or more of the examples 1 to 5 and, optionally, wherein for an operational frequency range, the range of supported coupling coefficients is larger than would be available if the resonant frequency was equal or substantially equal the maximum operational frequency.

Example 7 includes the subject matter of any one or more of the examples 1 to 6 and, optionally, wherein the maximum operational frequency is β× the resonant frequency, and wherein β<1 such as, for example, β≤0.99, ≤0.99, ≤0.98, ≤0.97, ≤0.96, ≤0.95, ≤0.94, ≤0.93, ≤0.92, ≤0.91, β≤0.9, or β≤0.89.

Example 8 includes the subject matter of any one or more of the examples 1 to 7 and, optionally, wherein the IWPT system is configured to vary the operational frequency between the minimum and maximum operational frequencies as a coupling coefficient between the transmitter coil and a receiver coil changes in order to regulate a load side current.

Example 9 includes the subject matter of any one or more of the examples 1 to 8 and, optionally, wherein the resonant frequency is determined by the operating parameter values of the components of the compensation circuit topology such, e.g., capacitor parameter values of an SS-compensation topology.

Example 10 pertains to a method for designing an IWPT system limited to operate in an operational frequency range between a minimum and maximum operational frequency, comprising:
for the maximum operational frequency of the IWPT system=β× a resonant frequency of the IWPT system, determining a coefficient β min that defines a minimum value of β;
determining all viable primary and secondary coil inductance pairs (Lp, Ls);
for each viable (Lp, Ls) pair, determining lower and upper bounds of a supported coupling coefficient range (kmin, kmax) for values of 0<β min≤β<1. Where applicable, 0<β min≤β≤1.
discarding all coupling coefficients not complying with 0<kmin<kmax<1; and
determining series compensation capacitor values based on a valid value of β.

Example 11 includes the subject matter of example 10 and, optionally, wherein the range of coupling coefficients supported within the operational frequency range is greater than would be supported if the maximum operational frequency was equal or was substantially equal to the resonant frequency.

Example 12 includes the subject matter of examples 10 and/or 11 and, optionally, wherein a range of coupling coefficients supported within the operational frequency range is maximized.

Example 13 includes the subject matter of any one or more of the examples 10 to 12 and, optionally, wherein the supported range of coupling coefficients is at least 40% more than what would be supported if the maximum frequency was equal or substantially equal to the resonant frequency.

Example 14 includes the subject matter of any one or more of the examples 10 to 13 and, optionally, wherein a range of supported coupling coefficients allows for a smaller operational frequency range than would be required if the resonant frequency was equal or substantially equal the maximum operational frequency.

Example 15 includes the subject matter of any one or more of the example 10 to 14 and, optionally, wherein for an operational frequency range, the range of supported coupling coefficients is larger than would be available if the resonant frequency was equal or substantially equal the maximum operational frequency.

Example 16 includes the subject matter of any one or more of the examples 10 to 15 and, optionally, wherein β≤0.9.

Example 17 includes the subject matter of any one or more of the examples 10 to 16 and, optionally, wherein the IWPT system is configured to vary the operational frequency between the minimum and maximum operational frequencies as a coupling coefficient between the transmitter coil and a receiver coil changes in order to regulate a load side current.

Example 18 includes the subject matter of any one or more of the examples 11 to 16 and, optionally, wherein the resonant frequency is determined by the operating parameter values of the components of the compensation circuit.

Example 19 pertains to a method for implementation of an IWPTL system, the method comprising: determining a design space including the vectors {β, Lₚ, Lₛ, kₘᵢₙ, kₘₐₓ}, wherein:
β is a maximum operational frequency divided by a resonant frequency of the IWPT system,
Lₚ, Lₛ, are respectively the primary and secondary coil inductance values of the IWPT system, and
kₘᵢₙ, kₘₐₓ are respectively the minimum and maximum coupling coefficients supported by the IWPT system;
selecting, based on the design space, a solution for implementation;
wherein the IWPT system is limited to operate in an operational frequency range between a minimum and the maximum operational frequency.

Example 20 includes the subject matter of example 19 and, optionally, determining a coefficient βₘᵢₙ that defines a minimum value of β;
determining all viable primary and secondary coil inductance pairs (Lₚ, Lₛ); and for each viable (Lₚ, Lₛ) pair, determining lower and upper bounds of the supported coupling coefficient range (kₘᵢₙ, kₘₐₓ) for values of 0<βₘᵢₙ≤β<1. Where applicable, 0<βₘᵢₙ≤β≤1.

Example 21 includes the subject matter of examples 19 and/or 20 and, optionally, further including, determining series compensation capacitor values.

Example 22 pertains to a device for implementation of an IWPT system, the device comprising:
a memory storing executable instructions; and
a processor configured to process the executable instructions, wherein the processing of the executable instructions results in the following steps:
determining a design space including the vectors {β, Lₚ, Lₛ, kₘᵢₙ, kₘₐₓ}, wherein:
β is a maximum operational frequency divided by a resonant frequency of the IWPT system,
Lₚ, Lₛ, are respectively the primary and secondary coil inductance values of the IWPT system, and
kₘᵢₙ, kₘₐₓ are respectively the minimum and maximum coupling coefficients supported by the IWPT system;
selecting, based on the design space, a solution for implementation,
wherein the IWPT system is limited to operate in an operational frequency range between a minimum and the maximum operational frequency.

Example 23 includes the subject matter of example 22 and, optionally, determining a coefficient βₘᵢₙ that defines a minimum value of β; determining all viable primary and secondary coil inductance pairs (Lₚ, Lₛ); and for each viable (Lₚ, Lₛ) pair, determining lower and upper bounds of the supported coupling coefficient range (kₘᵢₙ, kₘₐₓ) for values of 0<β_{min≤β<1}. Where applicable, 0<β min≤β≤1.

Example 24 includes the subject matter of examples 22 and/or 23 and, optionally, further including, determining compensation circuit topology parameter values such as, for example, series compensation capacitor values.

Example 25 pertains to a device for implementing an IWPT system limited to operate in an operational frequency range between a minimum and maximum operational frequency, the device comprising:
a memory storing executable instructions; and
a processor configured to process the executable instructions, wherein the processing of the executable instructions results in the following steps:
for the maximum operational frequency of the IWPT system=β× a resonant frequency of the IWPT system, determining a coefficient β min that defines a minimum value of β;
determining all viable primary and secondary coil inductance pairs (Lp, Ls);
for each viable (Lp, Ls) pair, determining lower and upper bounds of a supported coupling coefficient range (kmin, kmax) for values of 0<βₘᵢₙ≤β<1. Where applicable, 0<βₘᵢₙ≤β≤1.
discarding all coupling coefficients not complying with 0<kmin<kmax<1; and
determining series compensation capacitor values based on a valid value of β.

Example 26 includes the subject matter of example 25 and, optionally, wherein the range of coupling coefficients supported within the operational frequency range is greater than would be supported if the maximum operational frequency was equal or substantially equal to the resonant frequency.

Example 27 includes the subject matter of examples 25 or 26 and, optionally, wherein a range of coupling coefficients supported within the operational frequency range is maximized.

Example 28 includes the subject matter of any one or more of the examples 25 to 27 and, optionally, wherein the supported range of coupling coefficients is at least 40% more than what would be supported if the maximum operational frequency was equal or substantially equal to the resonant frequency.

Example 29 includes the subject matter of any one or more of the examples 25 to 28 and, optionally, wherein a range of supported coupling coefficients allows for a smaller operational frequency range than would be required if the resonant frequency was equal or substantially equal the maximum operational frequency.

Example 30 includes the subject matter of any one or more of the examples 25 to 29 and, optionally, wherein for an operational frequency range, the range of supported coupling coefficients is larger than would be available if the resonant frequency was equal or was substantially equal the maximum operational frequency.

Example 31 includes the subject matter of any one or more of the examples 25 to 30 and, optionally, wherein β≤0.9.

Example 32 includes the subject matter of any one or more of the examples 25 to 31 and, optionally, wherein the IWPT system is configured to vary the operational frequency between the minimum and maximum operational frequencies as a coupling coefficient between the transmitter coil and a receiver coil changes in order to regulate a load side current.

Example 33 includes the subject matter of any one or more of the examples 25 to 32 and, optionally, wherein the resonant frequency is determined by the operating parameter values of the components of the compensation circuit.

Unless otherwise defined, all technical and scientific terms used herein have the same meaning as commonly understood by one of ordinary skill in the art. The materials, methods, and examples provided herein are illustrative only and not intended to be limiting.

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware (HW) or by software (SW) on any operating system of any firmware, or by a combination thereof. For example, as hardware, selected steps of the disclosure could be implemented as a processor chip or a circuit. As software or algorithm, selected steps of the disclosure could be implemented as a plurality of software instructions being executed by a computer/processor using any suitable operating system. In any case, selected steps of the method and system of the disclosure could be described as being performed by a data processor such as, for example, a computing device for executing a plurality of instructions.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Any digital computer system, unit, device, module and/or engine exemplified herein can be configured or otherwise programmed to implement a method disclosed herein, and to the extent that the system, module and/or engine is configured to implement such a method, it is within the scope and spirit of the disclosure. Once the system, module and/or engine are programmed to perform particular functions pursuant to computer readable and executable instructions from program software that implements a method disclosed herein, it in effect becomes a special purpose computer particular to embodiments of the method disclosed herein. The methods and/or processes disclosed herein may be implemented as a computer program product that may be tangibly embodied in an information carrier including, for example, in a non-transitory tangible computer-readable and/or non-transitory tangible machine-readable storage device. The computer program product may be directly loadable into an internal memory of a digital computer, comprising software code portions for performing the methods and/or processes as disclosed herein.

The methods and/or processes disclosed herein may be implemented as a computer program that may be intangibly embodied by a computer readable signal medium. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a non-transitory computer or machine-readable storage device and that can communicate, propagate, or transport a program for use by or in connection with apparatuses, systems, platforms, methods, operations and/or processes discussed herein.

It should be understood that where the claims or specification refer to “a” or “an” element and/or feature, such reference is not to be construed as there being only one of that element. Hence, reference to “an element” or “at least one element” for instance may also encompass “one or more elements”.

Unless otherwise specified, terms such as, for example, ‘about’, ‘substantially’, and/or ‘close’ with respect to a magnitude or a numerical value may imply to be within an inclusive range of −10% to +10% of the respective magnitude or value.

It is important to note that the method may include is not limited to those diagrams or to the corresponding descriptions. For example, the method may include additional or even fewer processes or operations in comparison to what is described herein. In addition, embodiments of the method are not necessarily limited to the chronological order as illustrated and described herein.

Unless otherwise stated or applicable, the use of the expression “and/or” between the last two members of a list of options for selection indicates that a selection of one or more of the listed options is appropriate and may be made, and may be used interchangeably with the expressions “at least one of the following”, “any one of the following” or “one or more of the following”, followed by a listing of the various options.

As used herein, the phrase “A,B,C, or any combination of the aforesaid” should be interpreted as meaning all of the following: (i) A or B or C or any combination of A, B, and C, (ii) at least one of A, B, and C; and (iii) A, and/or B and/or C. This concept is illustrated for three elements (i.e., A,B,C), but extends to fewer and greater numbers of elements (e.g., A, B, C, D, etc.).

It is appreciated that certain features of the invention, which are, for clarity, described in the context of separate embodiments or example, may also be provided in combination in a single embodiment. Conversely, various features of the invention, which are, for brevity, described in the context of a single embodiment, example and/or option, may also be provided separately or in any suitable sub-combination or as suitable in any other described embodiment, example, or option of the invention. Certain features described in the context of various embodiments, examples and/or options are not to be considered essential features of those embodiments, unless the embodiment, example and/or option is inoperative without those elements.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as, for example, from 1 to 6 should be considered to have specifically disclosed subranges such as, for example, from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

While the invention has been described with respect to a limited number of embodiments, these should not be construed as limitations on the scope of the invention, but rather as exemplifications of some of the embodiments.

While certain features of the described implementations have been illustrated as described herein, many modifications, substitutions, changes, and equivalents will now occur to those skilled in the art. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations and embodiments described.

1. An inductive wireless power transfer (IWPT) system comprising:
a transmitter circuit and a receiver circuit that resonate at a resonant frequency and operate at an operational frequency;
wherein the operational frequency range is limited to operate between a minimum and maximum operational frequency;
wherein the transmitter circuit and receiver circuit are configured such that the resonant frequency is higher than the maximum operational frequency.

2. The IWPT system of claim 1, wherein a range of coupling coefficients supported within the operational frequency range is greater than would be supported if the maximum operational frequency was equal or substantially equal to the resonant frequency.

3. The IWPT system of claim 1, wherein a range of coupling coefficients supported within the operational frequency range is maximized.

4. The IWPT system of claim 1, wherein the supported range of coupling coefficients is at least 40% more than would be supported if the maximum operational frequency was equal or substantially equal to the resonant frequency.

5. The IWPT system of claim 1, wherein a range of supported coupling coefficients allows for a smaller operational frequency range than would be required if the resonant frequency was equal or substantially equal the maximum operational frequency.

6. The IWPT system of claim 1, wherein for an operational frequency range, the range of supported coupling coefficients is larger than would be available if the resonant frequency was equal or substantially equal the maximum operational frequency.

7. The IWPT system of claim 1, wherein the maximum operational frequency is β× the resonant frequency, and wherein β<1.

8. The IWPT system of claim 7, wherein β≤0.9.

9. The IWPT system of claim 1, wherein the IWPT system is configured to vary the operational frequency between the minimum and maximum operational frequencies as a coupling coefficient between the transmitter coil and a receiver coil changes in order to regulate a load side current.

10. The IWPT system of claim 1, wherein the resonant frequency is determined by the operating parameter values of the components of the compensation circuit topology.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. A device for implementation of an IWPT system, the device comprising:
a memory storing executable instructions; and
a processor configured to process the executable instructions, wherein the processing of the executable instructions results in the following steps:
determining a design space including the vectors {β, Lₚ, Lₛ, kₘᵢₙ, kₘₐₓ}, wherein:
β is a maximum operational frequency divided by a resonant frequency of the IWPT system,
Lₚ, Lₛ, are respectively the primary and secondary coil inductance values of the IWPT system, and
kₘᵢₙ, kₘₐₓ are respectively the minimum and maximum coupling coefficients supported by the IWPT system;
selecting, based on the design space, a solution for implementation,
wherein the IWPT system is limited to operate in an operational frequency range between a minimum and the maximum operational frequency.

24. The device of claim 23, further including, determining a coefficient βₘᵢₙ that defines a minimum value of β; determining all viable primary and secondary coil inductance pairs (Lₚ, Lₛ); and for each viable (Lₚ, Lₛ) pair, determining lower and upper bounds of the supported coupling coefficient range (kₘᵢₙ, kₘₐₓ) for values of 0<βₘᵢₙ≤β<1.

25. (canceled)

26. A device for implementing an IWPT system limited to operate in an operational frequency range between a minimum and maximum operational frequency, the device comprising:
a memory storing executable instructions; and
a processor configured to process the executable instructions, wherein the processing of the executable instructions results in the following steps:
for the maximum operational frequency of the IWPT system=β× a resonant frequency of the IWPT system, determining a coefficient βₘᵢₙ that defines a minimum value of β;
determining all viable primary and secondary coil inductance pairs (Lp, Ls);
for each viable (Lp, Ls) pair, determining lower and upper bounds of a supported coupling coefficient range (kmin, kmax) for values of 0<βₘᵢₙ≤β<1;
discarding all coupling coefficients not complying with 0<kmin<kmax<1; and
determining, based on a valid value of β, compensation topology parameter values.

27. The device of claim 26, wherein the range of coupling coefficients supported within the operational frequency range is greater than would be supported if the maximum operational frequency was equal or substantially equal to the resonant frequency.

28. (canceled)

29. The device of claim 26, wherein the supported range of coupling coefficients is at least 40% more than what would be supported if the maximum operational frequency was equal or substantially equal to the resonant frequency.

30. The device of claim 26, wherein a range of supported coupling coefficients allows for a smaller operational frequency range than would be required if the resonant frequency was equal or substantially equal the maximum operational frequency.

31. The device of claim 26, wherein for an operational frequency range, the range of supported coupling coefficients is larger than would be available if the resonant frequency was equal or was substantially equal the maximum operational frequency.

32. The device of claim 26, wherein β<1, or wherein β≤0.9.

33. The device of claim 26, wherein the IWPT system is configured to vary the operational frequency between the minimum and maximum operational frequencies as a coupling coefficient between the transmitter coil and a receiver coil changes in order to regulate a load side current.

34. The device of claim 26, wherein the resonant frequency is determined by the operating parameter values of the components of the compensation circuit.
